(19) United States
(12) Patent Application Publication
(10) Pub. No.: US 2015/0295281 A1
(43) Pub. Date: Oct. 15, 2015

(54) Vanadium Redox Battery

(71) Applicants: Brother Kogyo Kabushiki Kaisha, Nagoya-shi (JP); Tohoku Techno Arch Co., Ltd., Sendai-shi (JP)

(72) Inventors: Shigeki Yoshida, Toyoake-shi (JP); Tomoo Yamamura, Sendai-shi (JP)

(21) Appl. No.: 14/750,602

(22) Filed: Jun. 25, 2015

Related U.S. Application Data
(63) Continuation-in-part of application No. PCT/JP2013/084776, filed on Dec. 26, 2013.

(30) Foreign Application Priority Data
Dec. 27, 2012 (JP) 2012-285409

(51) Int. Cl. H01M 10/42; H01M 8/18; H01M 10/36

(52) U.S. Cl. CPC H01M 10/4235; H01M 10/36; H01M 8/188; H01M 2220/10; H01M 2250/10

(57) ABSTRACT

A vanadium redox battery is a battery capable of charging and discharging utilizing an oxidation-reduction reaction of vanadium as an active material. The vanadium redox battery includes a cathode and an anode. The vanadium redox battery includes an auxiliary electrode that is provided in at least one of the cathode and the anode.

### CROSS-REFERENCE TO RELATED APPLICATION

The present application is a continuation-in-part of International Application PCT/JP2013/084776, filed on Dec. 26, 2013, which claims the benefit of Japanese Patent Application No. 2012-285409, filed on Dec. 27, 2012, each of which is incorporated herein by reference.

### FIELD OF DISCLOSURE

Aspects described herein relate to a vanadium redox battery.

### BACKGROUND

As one of secondary batteries, vanadium redox flow batteries using vanadium as an active material are known. A vanadium redox flow battery is a battery capable of charging and discharging utilizing an oxidation-reduction reaction of an active material in an electrolyte solution.

In particular, vanadium redox flow batteries that use divalent, trivalent, tetravalent, and pentavalent vanadium ions as active materials and also circulate a sulfuric acid solution of vanadium retained in a tank between the tank and a cell are used in the field of large power storage.

A vanadium redox flow battery comprises a cathode solution tank to store a cathode solution, which is an active material on the cathode side, an anode solution tank to store an anode solution, which is an active material on the anode side, and a cell to carry out charge and discharge. The cathode solution and the anode solution are circulated between the cell and the tank by a pump. The cell is provided with a cathode, an anode, and an ion exchange membrane to partition them. Battery reaction formulae in the cathode solution and in the anode solution are respectively as the following formulae (1), (2).

Cathode: VO²⁺(aq)+H₂O [symbol] VO₂⁺(aq)+e⁻+2H⁺ (1)

Anode: V³⁺(aq)+e⁻ [symbol] V²⁺(aq) (2)

In the above formulae (1) and (2), “ [symbol] ” denotes chemical equilibrium. The (aq) described next to the ions means that the ions are present in solutions.

As a conventional vanadium redox flow battery, a stationary vanadium redox battery is known. In addition, a vanadium solid-salt battery is known.

In this specification, redox batteries using vanadium, vanadium ions, or a compound containing vanadium as an active material are called as “vanadium redox batteries”, overall. Vanadium redox flow batteries, stationary vanadium redox batteries, and vanadium solid-salt batteries are thus included in the “vanadium redox batteries”.

### BRIEF SUMMARY

When a SOC (State of Charge) of a vanadium redox flow battery is zero, most of the cathode solution contains V⁴⁺(aq) and most of the anode solution contains V³⁺(aq). At this point, an open circuit voltage of the battery is approximately 1.1 volts. By applying a sufficiently large voltage between the cathode and the anode using an external power source, it is possible to charge the vanadium redox flow battery. As the charging of the battery proceeds, V⁴⁺(aq) in the cathode solution is oxidized to V⁵⁺(aq), and meanwhile, V³⁺(aq) in the anode solution is reduced to V²⁺(aq). When battery charge is completed and the SOC reaches 100%, the open circuit voltage of the battery becomes approximately 1.58 volts. Conventional vanadium redox batteries used to have a problem that the state of oxidation and reduction in the cathode and the anode is off balance while charge and discharge of the battery are repeated.

When the state of oxidation and reduction in the cathode and the anode is off balance while charge and discharge of the battery are repeated, the active material in the anode turns out to contain tetravalent vanadium in a state where the battery is uncharged (SOC=zero %). In this case, even when battery charge is completed, a part of the active material in the anode still remains as trivalent and it is sometimes not possible to extract sufficient electrical energy from a part of the active material.

As a method of detecting an oxidation status in the cathode and the anode, a method that uses the Nernst equation, describing relationship between density (activity) of the reactant and potential, is known. However, there was no technique capable of individually detecting the state of oxidation and reduction in the cathode and the anode of a vanadium redox battery. In addition, when the state of oxidation and reduction in the cathode and the anode in a vanadium redox battery was off balance, there was no technique capable of recovering the balance of the state of oxidation and reduction.

Aspects described herein provide a vanadium redox battery that includes an auxiliary electrode provided in at least one of a cathode and an anode.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 illustrates a configuration example of a vanadium solid-salt battery having an auxiliary electrode disposed in a cathode.

FIG. 2 is an illustration of balance of an oxidation status in a cathode and an anode of the vanadium redox battery.

FIG. 3 is an illustration of a state where an oxidation status in a cathode and an anode of a vanadium redox battery is off balance.

FIG. 4 illustrates a configuration example of a vanadium solid-salt battery having auxiliary electrodes disposed in a cathode and an anode.

FIG. 5 is a front view of a first auxiliary electrode provided so as to abut on a separator.

FIG. 6 is a cross-sectional view of the first auxiliary electrode illustrated in FIG. 5 taken from line A-A.

FIG. 7 is a front view illustrating a first auxiliary electrode provided in a grid.

FIG. 8 is a cross-sectional view of the first auxiliary electrode illustrated in FIG. 7 taken from line B-B.

FIG. 9 illustrates a measurement result of an oxidation status of a vanadium solid-salt battery.

FIG. 10 illustrates a measurement result of an oxidation status of a vanadium solid-salt battery and illustrates a state where the oxidation status is off balance.

FIG. 11 illustrates a measurement result of a voltage of a vanadium solid-salt battery after modulating an oxidation status in an anode.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

In the present disclosure, “oxidation status” may be replaced by “redox status”.

A vanadium redox battery uses vanadium, vanadium ions, or a compound containing vanadium as active materials in the cathode and the anode. Vanadium (V) is an element that may be in several types, including divalence, trivalence, tetravalence, and pentavalence, of oxidation states. Vanadium is an element that produces a potential difference in magnitude to the extent useful for a battery.

Vanadium redox batteries include vanadium redox flow batteries, stationary vanadium redox batteries, vanadium solid-salt batteries, and the like. In the following description, an example of applying the present disclosure to a vanadium solid-salt battery is described.

An anode active material of a vanadium solid-salt battery includes vanadium having an oxidation number varied between divalence and trivalence by an oxidation-reduction reaction. An anode active material of a vanadium solid-salt battery may also include vanadium ions having an oxidation number varied between divalence and trivalence by an oxidation-reduction reaction. An anode active material of a vanadium solid-salt battery may also include cations that contain vanadium having an oxidation number varied between divalence and trivalence by an oxidation-reduction reaction. An anode active material of a vanadium solid-salt battery may also include solid vanadium salt that contains vanadium having an oxidation number varied between divalence and trivalence by an oxidation-reduction reaction. An anode active material of a vanadium solid-salt battery may also include complex salt that contains vanadium having an oxidation number varied between divalence and trivalence by an oxidation-reduction reaction.

A cathode active material of a vanadium solid-salt battery includes vanadium having an oxidation number varied between pentavalence and tetravalence by a reduction-oxidation reaction. A cathode active material of a vanadium solid-salt battery may also include vanadium ions having an oxidation number varied between pentavalence and tetravalence by a reduction-oxidation reaction. A cathode active material of a vanadium solid-salt battery may also include cations that contain vanadium having an oxidation number varied between pentavalence and tetravalence by an oxidation-reduction reaction. A cathode active material of a vanadium solid-salt battery may also include solid vanadium salt that contains vanadium having an oxidation number varied between pentavalence and tetravalence by a reduction-oxidation reaction. A cathode active material of a vanadium solid-salt battery may also include complex salt that contains vanadium having an oxidation number varied between pentavalence and tetravalence by a reduction-oxidation reaction.

Vanadium solid-salt batteries use a solid material as active materials in the cathode and the anode, so that there is little concern for fluid leakage and the like. In addition, using a solid material as active materials in the cathode and the anode, vanadium solid-salt batteries are excellent in safety and also have high energy density.

Examples of the anode active material that may be used for a vanadium solid-salt battery include a vanadium sulfate (II) n hydrate, a vanadium sulfate (III) n hydrate, and the like. The anode active material may be added to a sulfuric acid aqueous solution.

Examples of the cathode active material that may be used for a vanadium solid-salt battery include a vanadium oxysulfate (IV) n hydrate, a vanadium dioxysulfate (V) n hydrate, and the like. The cathode active material may be added to a sulfuric acid aqueous solution.

A reaction formula of the cathode active material while charging and discharging the vanadium solid-salt battery is as expressed in, for example, the following formula (3).

Cathode: VOX₂·nH₂O(s) [symbol] VO₂X·mH₂O(s)+HX+H⁺e⁻ (3)

A reaction formula of the anode active material while charging and discharging the vanadium solid-salt battery is as expressed in, for example, the following formula (4).

Anode: VX₃·nH₂O(s)+e⁻ [symbol] 2VX₂·mH₂O(s)+X⁻ (4)

In the formulae (3) and (4), X denotes monovalent anions.

In the formulae (3) and (4), n may be various values. For example, a vanadium oxysulfate (IV) n hydrate and a vanadium dioxysulfate (V) n hydrate do not always have the same number of hydration waters. This is similar in chemical reaction formulae and substance names shown below.

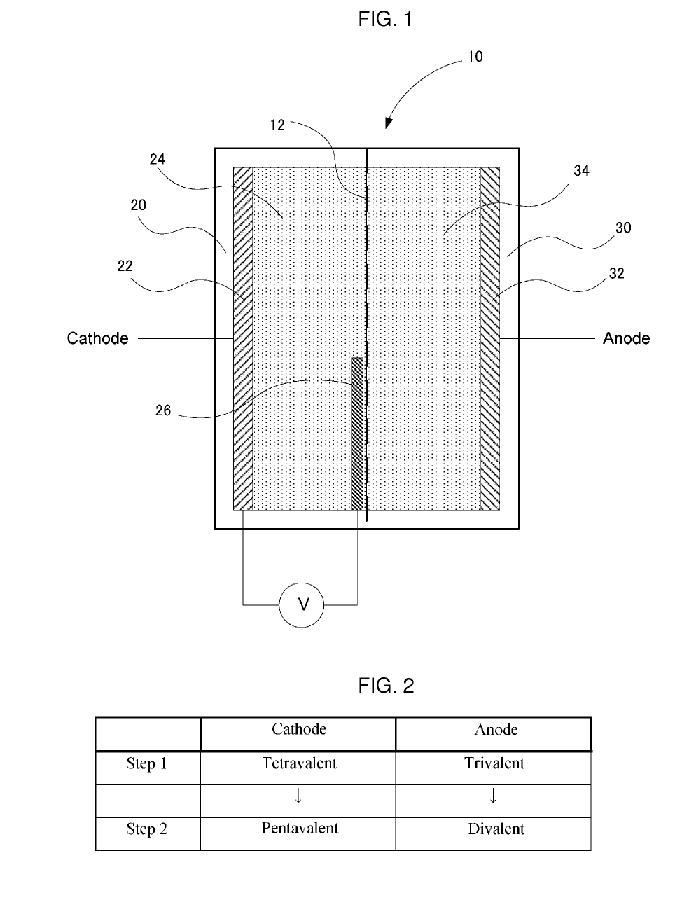

FIG. 1 illustrates a configuration example of a vanadium solid-salt battery.

As illustrated in FIG. 1, a vanadium solid-salt battery 10 is provided with a cathode 20 and an anode 30 that are separated by a separator 12. The cathode 20 has a first electrode 22 (cathode) disposed therein, and the anode 30 has a second electrode 32 (anode) disposed therein. Between the first electrode 22 and the separator 12, a first current collector 24 is provided. Between the second electrode 32 and the separator 12, a second current collector 34 is provided. The cathode 20 is filled with a mixture, which is the cathode active material, of a vanadium oxysulfate (IV) n hydrate and a sulfuric acid aqueous solution. The anode 30 is filled with a mixture, which is the anode active material, of a vanadium sulfate (III) n hydrate and a sulfuric acid aqueous solution. By connecting an electrical resistance of appropriate magnitude between the first electrode 22 and the second electrode 32, the battery is discharged. By applying a voltage of sufficient magnitude between the first electrode 22 and the second electrode 32, the battery is charged.

The first electrode 22 has an electrode surface abutting on the first current collector 24. The first current collector 24 is formed with an electrical conductor. The first current collector 24 carries the cathode active material. The first electrode 22 is capable of carrying out exchange of electrons with the cathode active material via the first current collector 24.

The second electrode 32 has an electrode surface abutting on the second current collector 34. The second current collector 34 is formed with an electrical conductor. The second current collector 34 carries the anode active material. The second electrode 32 is capable of carrying out exchange of electrons with the anode active material via the second current collector 34.

The first current collector 24 may be felt made of carbon fiber, a sheet made of carbon fiber, activated carbon, or the like. Among them, felt made of carbon fiber is particularly preferred. It is possible to increase the contact area of the first current collector 24 with the cathode active material by using felt made of carbon fiber as the first current collector 24, so that it is possible to enhance the battery output more.

The second current collector 34 may be felt made of carbon fiber, a sheet made of carbon fiber, activated carbon, or the like. Among them, felt made of carbon fiber is particularly preferred. It is possible to increase the contact area of the second current collector 34 with the anode active material by using felt made of carbon fiber as the second current collector 34, so that it is possible to enhance the battery output more.

The separator 12 is, for example, an ion exchange membrane capable of letting hydrogen ions (protons) selectively pass therethrough. The separator 12 may also be, for example, a porous film and the like.

The separator 12 is, for example, an ion exchange membrane, such as Selemion APS® (manufactured by Asahi Glass Co., Ltd.) and Nafion® (manufactured by Du Pont Kabushiki Kaisha). The separator 12 is also, for example, an ion exchange membrane, such as Neosepta® (manufactured by ASTOM Corp.).

As illustrated in FIG. 1, the cathode 20 has a first auxiliary electrode 26 disposed therein. It is preferred that the first auxiliary electrode 26 includes at least one of carbon, platinum, and gold, having good conductivity. The first auxiliary electrode 26 may contain other material such as a binder or an active material. The first auxiliary electrode 26 may be disposed anywhere within the cathode 20. It is preferred that the first auxiliary electrode 26 is disposed in a position adjacent to the separator 12.

FIG. 2 is an illustration of balance of an oxidation status in a cathode and an anode of the vanadium redox battery. As illustrated in FIG. 2, in a state where the vanadium solid-salt battery 10 is uncharged (SOC=zero %), vanadium as the cathode active material is tetravalent and vanadium as the anode active material is trivalent. As the battery charge proceeds, vanadium in the cathode changes from tetravalent to pentavalent and vanadium in the anode changes from trivalent to divalent. In a state where the battery charge is completed (SOC=100%), all vanadium in the cathode becomes pentavalent and all vanadium in the anode becomes divalent.

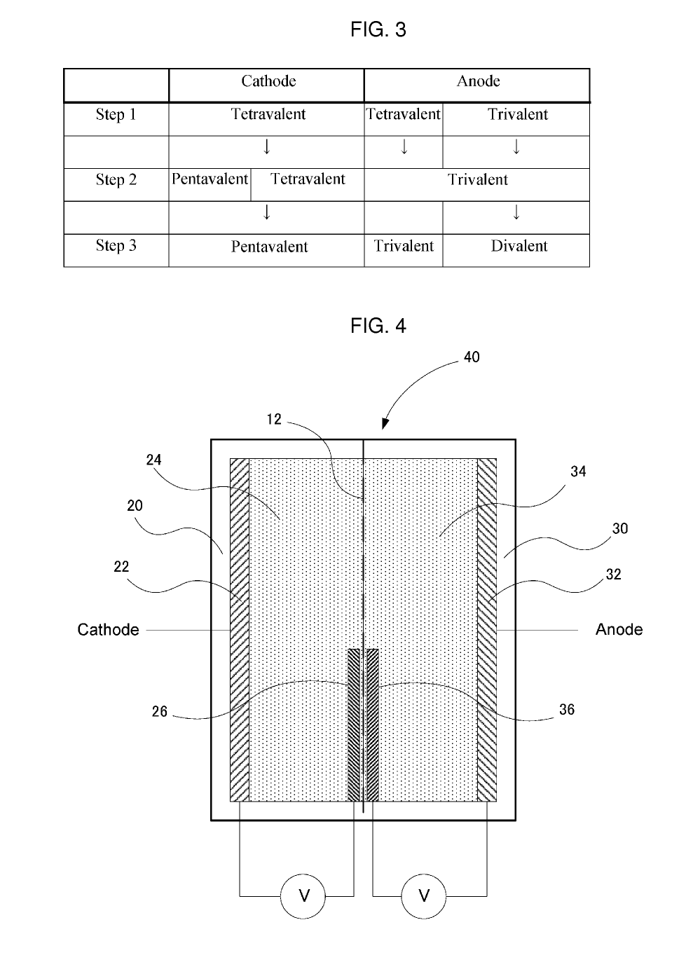

FIG. 3 is an illustration of a state where an oxidation status in a cathode and an anode of a vanadium redox battery is off balance.

As illustrated in FIG. 3, when the state of oxidation and reduction in the cathode and the anode is off balance while charge and discharge of the battery are repeated, the anode active material of the battery in an uncharged state turns out to contain tetravalent vanadium. In this case, even when the battery charge is completed, a part of the anode active material still remains as trivalent, not divalent. As a result, it becomes difficult to extract electrical energy from a part of the active material, so that the battery capacity decreases.

When the oxidation status in the cathode and the anode is off balance in a conventional vanadium redox battery, the balance has to be modulated to be recovered to the original state. Conventionally, when the oxidation status in the cathode and the anode is off balance, it used to be an actual situation that charge and discharge of the battery has to be repeated while storage capacity of the battery remains decreased.

In order to solve such problems, the vanadium solid-salt battery 10 (vanadium redox battery) of the present embodiment has the first auxiliary electrode 26 disposed in the cathode 20. By using the first auxiliary electrode 26, it is possible to detect oxidation status in the cathode and the anode, respectively. In addition, it is possible to modulate oxidation status in the cathode and the anode, respectively. By modulating oxidation status in the cathode and the anode respectively, it is possible to balance the oxidation status of the cathode with the oxidation status of the anode.

Specifically, by measuring a voltage (potential difference) between the first electrode 22 and the first auxiliary electrode 26, it is possible to measure the oxidation status in the cathode. Relationship between the density (activity) of the active material and the electrode potential is described by the Nernst equation. It is thus possible to detect the density of the cathode active material or the SOC of the cathode by measuring the voltage (potential difference) between the first electrode 22 and the first auxiliary electrode 26.

In addition, it is possible to modulate the oxidation status of the cathode by applying a predetermined voltage or greater between the first electrode 22 and the first auxiliary electrode 26. By modulating the oxidation status of the cathode, it is possible to balance the oxidation status of the cathode with the oxidation status of the anode. This enables recovery of the balance of oxidation status in the cathode and the anode.

That is, during charge and discharge of the battery, the same number of electrons is exchanged respectively in the cathode and the anode, so that the reaction of the active materials proceeds one to one in the cathode and the anode. When the oxidation status in the cathode and the anode is off balance, it is thus not possible to recover the balance of oxidation status in the cathode and the anode only by charge and discharge of the battery.

According to the vanadium solid-salt battery 10 of the present embodiment, it is possible to carry out battery charge only in the cathode by applying a predetermined voltage or greater between the first electrode 22 and the first auxiliary electrode 26. Alternatively, it is possible to carry out battery discharge only in the cathode by connecting an electrical resistance of appropriate magnitude between the first electrode 22 and the first auxiliary electrode 26. This enables individual modulation of the oxidation status of the cathode, so that it is possible to recover the balance of oxidation status in the cathode and the anode.

According to the vanadium solid-salt battery 10 of the present embodiment, it is possible to recover the balance of oxidation status in the cathode and the anode. As a result, it is possible to achieve the vanadium solid-salt battery 10 in which the storage capacity rarely decreases even when charge and discharge of the battery are repeated.

Although an example of disposing the first auxiliary electrode 26 in the cathode 20 is described in the above embodiment, the description is also similar when the first auxiliary electrode 26 is disposed in the anode 30. In this case, it is possible to measure the oxidation status in the anode by measuring the voltage (potential difference) between the second electrode 32 and the first auxiliary electrode 26. In addition, it is possible to modulate the oxidation status of the anode by applying a voltage of sufficient magnitude between the second electrode 32 and the first auxiliary electrode 26. By modulating the oxidation status of the anode, it is possible to balance the oxidation status of the cathode with the oxidation status of the anode.

FIG. 4 illustrates a configuration example of a vanadium solid-salt battery 40 provided with auxiliary electrodes both in a cathode and an anode.

As illustrated in FIG. 4, the first auxiliary electrode 26 may be disposed in the cathode 20 and a second auxiliary electrode 36 may also be disposed in the anode 30. In this case, it is possible to measure the oxidation status in the cathode by measuring the voltage (potential difference) between the first electrode 22 and the first auxiliary electrode 26. In addition, it is possible to measure the oxidation status in the anode by measuring the voltage (potential difference) between the second electrode 32 and the second auxiliary electrode 36.

It is possible to modulate the oxidation status of the cathode by applying a predetermined voltage or greater between the first electrode 22 and the first auxiliary electrode 26. By modulating the oxidation status of the cathode, it is possible to balance the oxidation status of the cathode with the oxidation status of the anode. This enables recovery of the balance of oxidation status in the cathode and the anode.

It is possible to modulate the oxidation status of the anode by applying a predetermined voltage or greater between the second electrode 32 and the second auxiliary electrode 36. By modulating the oxidation status of the anode, it is possible to balance the oxidation status of the cathode with the oxidation status of the anode. This enables recovery of the balance of oxidation status in the cathode and the anode.

According to the vanadium solid-salt battery 40 provided with the first auxiliary electrode 26 and the second auxiliary electrode 36 respectively in the cathode and the anode, it is possible to measure the oxidation status in the cathode and the anode more precisely than the vanadium solid-salt battery provided with an auxiliary electrode in either the cathode or the anode. The vanadium solid-salt battery 40 provided with the first auxiliary electrode 26 and the second auxiliary electrode 36 respectively in the cathode and the anode is capable of modulating the oxidation status in the cathode and the anode more precisely. Accordingly, even when charge and discharge of the battery are repeated, it is possible to achieve the vanadium solid-salt battery 40 in which the storage capacity rarely decreases.

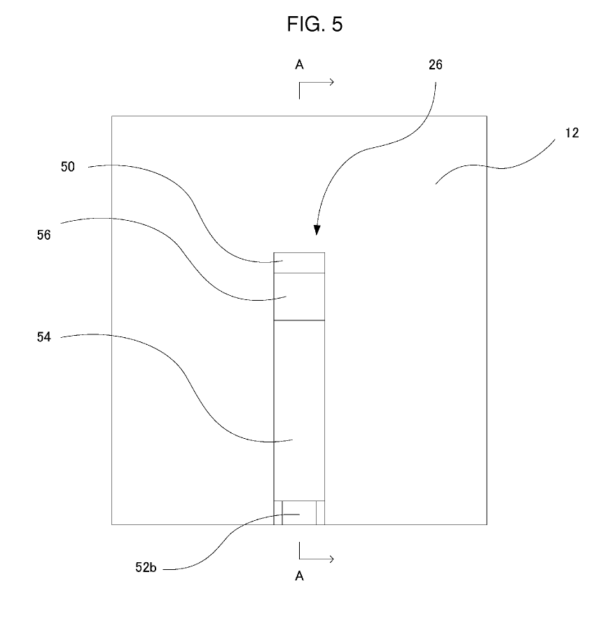

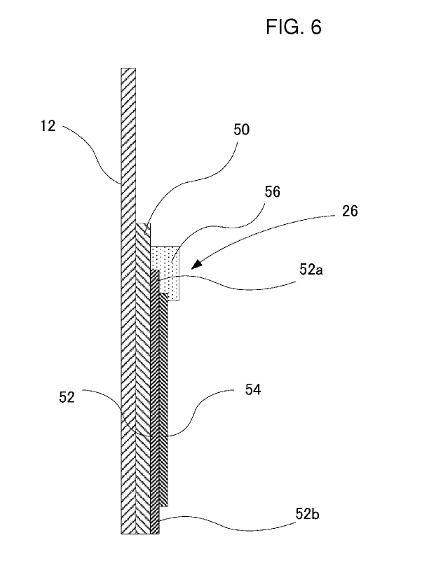

FIG. 5 is a front view of the first auxiliary electrode 26 provided so as to abut on the separator 12. FIG. 6 is a cross-sectional view of the first auxiliary electrode 26 illustrated in FIG. 5 taken from line A-A.

As illustrated in FIG. 5 and FIG. 6, an insulator film 50 is applied on an approximate center portion of a cathode side surface of the separator 12. On a surface of the insulator film 50, a carbon film 52 is applied. On a surface of the carbon film 52, an insulator film 54 is applied. An upper end portion 52a of the carbon film 52 is not coated with the insulator film 54 and is coated with a porous film 56. In other words, the first auxiliary electrode 26 is configured with the insulator film 50, the carbon film 52, and the porous film 56 laminated on the surface of the separator 12.

By the insulator film 54 and the porous film 56, the carbon film 52 is electrically insulated from the first current collector 24. The insulator film 50, 54 is, for example, insulating varnish. The carbon film 52 is, for example, a carbon coating film. The porous film 56 is, for example, a porous film made of polypropylene.

On the lower end portion 52b of the carbon film 52, the insulator film 54 is not applied and the lower end portion 52b is exposed. To the exposed lower end portion 52b, a terminal to measure the voltage between the first electrode 22 and the first auxiliary electrode 26 or a terminal to apply a voltage between the first electrode 22 and the first auxiliary electrode 26 is connected.

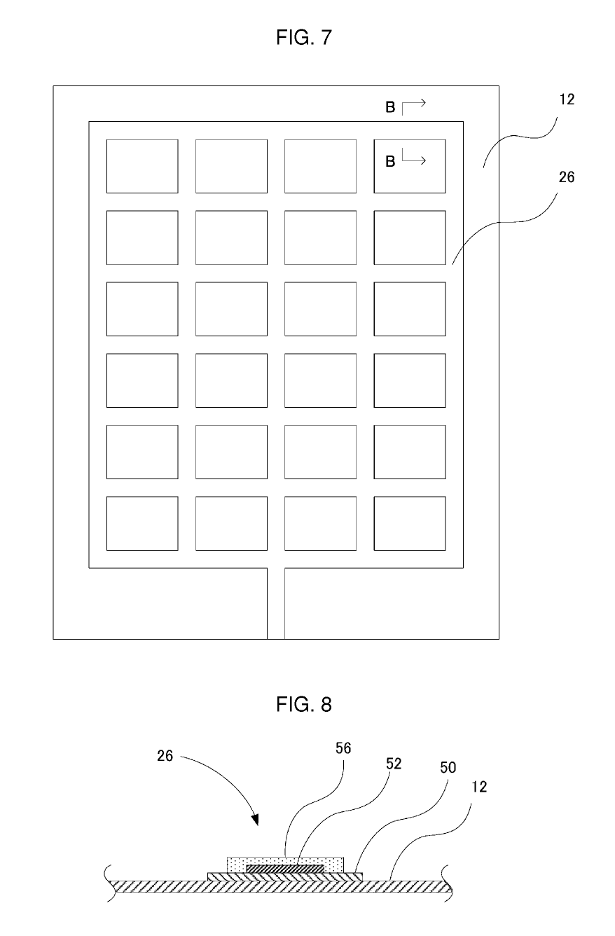

FIG. 7 is a front view illustrating another embodiment of the first auxiliary electrode 26. FIG. 8 is a cross-sectional view of the first auxiliary electrode 26 illustrated in FIG. 7 taken from line B-B.

As illustrated in FIG. 7, on the cathode side surface of the separator 12, the first auxiliary electrode 26 is provided in a grid over the entire surface. By providing the first auxiliary electrode 26 in a grid in such a manner, it is possible to measure the oxidation status in the cathode more accurately. In addition, it is possible to modulate the oxidation status in the cathode more accurately.

As illustrated in FIG. 7 and FIG. 8, on the cathode side surface of the separator 12, the insulator film 50 is applied in a grid. On a surface of the insulator film 50, the carbon film 52 is applied. A surface of the carbon film 52 is coated with the porous film 56. In other words, the first auxiliary electrode 26 is configured with the insulator film 50, the carbon film 52, and the porous film 56 laminated on the surface of the separator 12. By the porous film 56, the carbon film 52 is electrically insulated from the first current collector 24. The insulator film 50 is, for example, insulating varnish. The carbon film 52 is, for example, a carbon coating film. The porous film 56 is, for example, a porous film made of polypropylene.

Although specific configuration examples of the first auxiliary electrode 26 has been described using FIG. 5 through FIG. 8, it is also possible to configure the second auxiliary electrode 36 similarly.

In the following description, an example of use of the battery of the present disclosure is described.

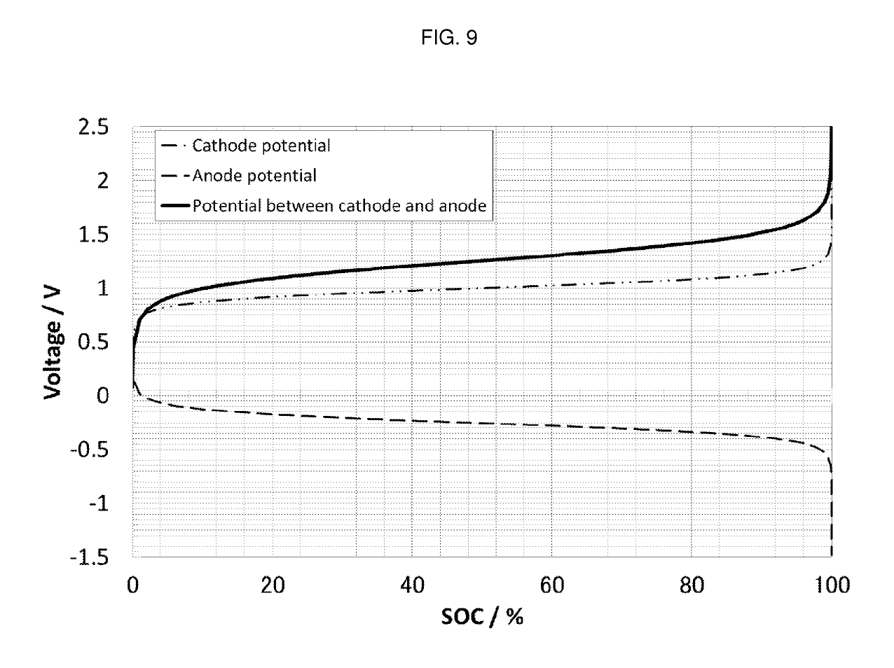

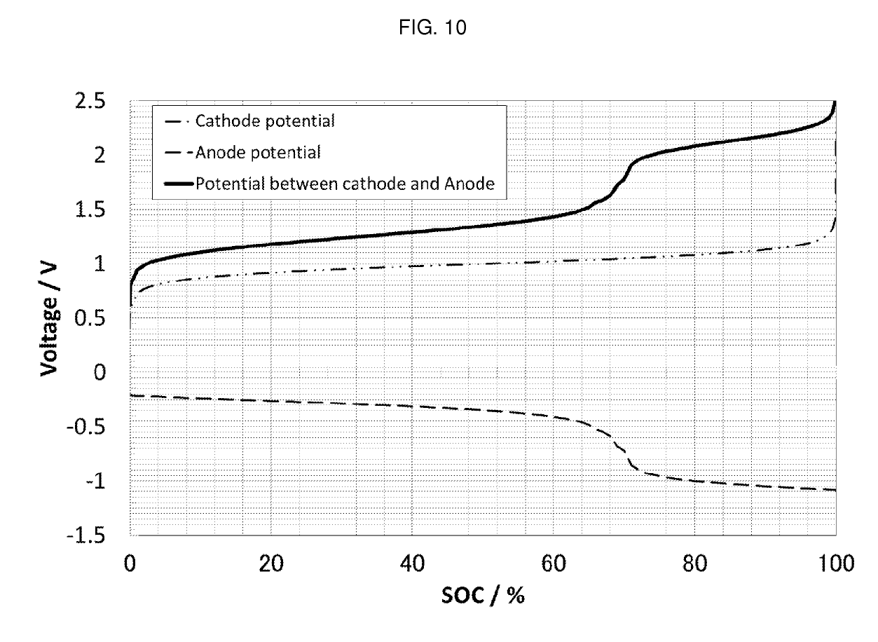

Firstly, using the vanadium solid-salt battery described above, an experiment to measure the oxidation status in the cathode and the anode was carried out. Results are illustrated in FIG. 9 and FIG. 10.

In FIG. 9 and FIG. 10, the abscissa represents the State of Charge (SOC) (%) and the ordinate represents potential (V). FIG. 9 illustrates a state where the oxidation status in the cathode and the anode is balanced, and FIG. 10 illustrates a state where the oxidation status in the cathode and the anode is off balance.

As illustrated in FIG. 9, in a normal vanadium solid-salt battery, as the charge depth rose, tetravalent vanadium changed to pentavalent vanadium in the cathode and trivalent vanadium changed to divalent vanadium in the anode. In other words, the oxidation status in the cathode and the anode was balanced.

As illustrated in FIG. 10, in a vanadium solid-salt battery where the oxidation status in the cathode and the anode was off balance, a part of trivalent vanadium did not change to divalent in the anode 30. It was thus not possible to extract a part of electrical energy of the anode active material, resulting in a decrease in the storage capacity of the battery.

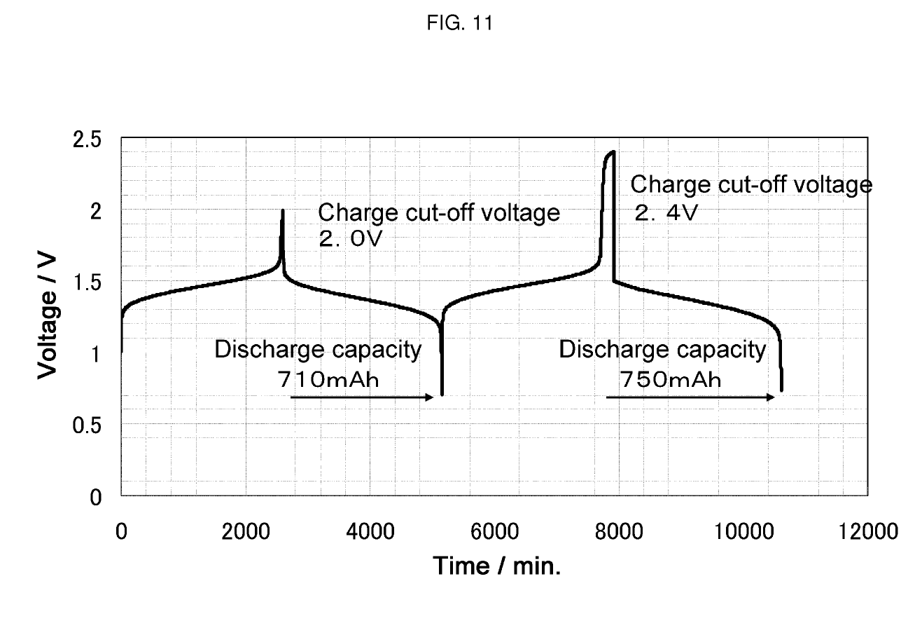

Next, using the vanadium solid-salt battery described above, an experiment to modulate respective oxidation status of in the cathode and the anode was carried out. Specifically, by applying a voltage between the second electrode (anode) and the second auxiliary electrode, only the anode was overcharged. Results are illustrated in FIG. 11.

In FIG. 11, the abscissa represents time (min), and the ordinate represents a voltage (V) between the cathode and the anode.

As illustrated in a graph on the left of FIG. 11, the vanadium solid-salt battery where the oxidation status in the cathode and the anode is off balance had a charge cut-off voltage of 2.0 V and discharge capacity of 710 mAh, and it was not possible to obtain sufficient discharge capacity.

As illustrated in a graph on the right of FIG. 11, the vanadium solid-salt battery after overcharging the anode and modulating the oxidation status in the anode had a charge cut-off voltage of 2.4 V and discharge capacity of 750 mAh, and it was possible to recover sufficient discharge capacity that used to be obtained by the vanadium solid-salt battery immediately after production.

Although an example of applying the present disclosure to a vanadium solid-salt battery is described in the above example, the present disclosure may also be applied to other vanadium redox batteries (vanadium redox flow batteries, stationary vanadium redox batteries).

As have been described above, according to the vanadium redox battery of the present disclosure, it is possible to individually detect an oxidation status in a cathode and an anode. In addition, when an oxidation status in a cathode and an anode is off balance, it is possible to recover the balance of an oxidation status.

What is claimed is:

1. A vanadium redox battery comprising:
an auxiliary electrode provided in at least one of a cathode and an anode.

2. The vanadium redox battery according to claim 1, wherein the auxiliary electrode is an electrode to measure potential of at least one of the cathode and the anode.

3. The vanadium redox battery according to claim 1, wherein the auxiliary electrode is an electrode to balance an oxidation status between the cathode and the anode by applying a voltage to the cathode.

4. The vanadium redox battery according to claim 1, wherein the auxiliary electrode is an electrode to balance an oxidation status between the cathode and the anode by applying a voltage to the anode.

5. The vanadium redox battery according to claim 1, wherein the auxiliary electrode includes at least one of carbon, platinum, and gold.

6. The vanadium redox battery according to claim 1, further comprising a separator to separate the cathode from the anode, the separator being provided between the cathode and the anode,
wherein the auxiliary electrode is configured with an insulator film, a carbon film, and a porous film that are laminated on a surface of the separator.

7. The vanadium redox battery according to claim 1, wherein
at least one of the cathode and the anode comprises an electrode, a current collector, and the auxiliary electrode,
the current collector comprises an active material,
the electrode abuts on the current collector, and
the auxiliary electrode abuts on the current collector.

8. The vanadium redox battery according to claim 1, further comprising a separator to separate the cathode from the anode, the separator being provided between the cathode and the anode,
wherein the auxiliary electrode is provided near the separator.

9. The vanadium redox battery according to claim 1, further comprising a separator to separate the cathode from the anode, the separator being provided between the cathode and the anode,
wherein the auxiliary electrode is provided adjacent to the separator.

10. The vanadium redox battery according to claim 1, wherein the auxiliary electrode is provided in a grid.
